(19) United States
(12) Patent Application Publication
(10) Pub. No.: US 2019/0355358 A1
(43) Pub. Date: Nov. 21, 2019

(54) DETERMINING DEVICE, ELECTRONIC APPARATUS, RESPONSE SYSTEM, METHOD OF CONTROLLING DETERMINING DEVICE, AND STORAGE MEDIUM

(71) Applicant: SHARP KABUSHIKI KAISHA, Sakai City (JP)

(72) Inventor: SHIGEFUMI URATA, Sakai City (JP)

(21) Appl. No.: 16/416,209

(22) Filed: May 18, 2019

(30) Foreign Application Priority Data
May 18, 2018 (JP) 2018-096495

(51) Int. Cl. G10L 15/22; G10L 15/30; G10L 15/08

(52) U.S. Cl. CPC G10L 15/22; G10L 15/30; G10L 2015/088; G10L 2015/223; G10L 15/08

(57) ABSTRACT

Whether or not to respond to audio from a television set, a radio receiver, or the like is appropriately determined. A server control section includes: an information acquiring section configured to acquire a recognized information item; and a response determining section configured to determine whether or not to cause an electronic apparatus to carry out a response that corresponds to the recognized information item, the response determining section being configured to determine not to cause the electronic apparatus to carry out the response if a time and a result of the speech recognition which are contained in the recognized information item match a time or a time period and a result of speech recognition which are contained in a determination information item, respectively.

This Nonprovisional application claims priority under 35 U.S.C. § 119 on Patent Application No. 2018-096495 filed in Japan on May 18, 2018, the entire contents of which are hereby incorporated by reference.

### TECHNICAL FIELD

One or more embodiments of the present invention relates to a determining device and the like each of which determines whether or not to prepare a message that is to be outputted from an electronic apparatus.

### BACKGROUND ART

Electronic apparatuses that carry out speech recognition of an acquired user's speech and output a response message corresponding to the result of the speech recognition are known. In regard to such electronic apparatuses, various techniques have been developed to carry out the speech recognition and the output of the response message each at the right time.

For example, Patent Literature 1 discloses a speech recognition apparatus that starts speech recognition upon receipt of a particular word or phrase as a trigger. The particular word or phrase recognized by the speech recognition apparatus is a word or phrase used in limited situations, such as a word or phrase that is not often used in ordinary conversation, a word or phrase that is not in the native language of a speaker, or a word or phrase that has the meaning of a voice activation command. This prevents speech recognition that is not intended by the speaker from being started upon receipt of ordinary conversation as a trigger.

### CITATION LIST

### Patent Literature

### [Patent Literature 1] Japanese Patent Application Publication, Tokukai No. 2004-301875

### SUMMARY OF INVENTION

### Technical Problem

However, according to the technique disclosed in Patent Literature 1, if audio from a television set, radio receiver, or the like contains the aforementioned particular word or phrase, the speech recognition apparatus may start speech recognition at a time not intended by the speaker. If the audio from a television set, radio receiver, or the like is unexpectedly recognized and a response message is outputted as above, this will highly likely hinder the interaction between the user and the electronic apparatus.

On the other hand, from the viewpoint of causing an electronic apparatus to output a response message “at the right time”, it may not be necessary to shut out all the sounds from a television set, radio receiver, or the like. For example, if the electronic apparatus outputs a speech in response to the sounds of a baseball game broadcast on TV, this will boost the mood of a user watching TV (e.g., watching baseball game).

One aspect of the present disclosure was made in view of the above issues, and an object thereof is to provide a determining device and the like which are capable of appropriately determining whether or not to respond to the audio from a television set, radio receiver, or the like.

### Solution to Problem

In order to attain the above object, a determining device in accordance with one aspect of the present invention is a determining device configured to determine whether or not to cause an electronic apparatus that includes a speech input device to respond, the determining device including: a recognized information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out; and a response determining section configured to determine whether or not to cause the electronic apparatus to carry out a response that corresponds to the recognized information item, the response determining section being configured to refer to a determination information item which has been stored in a storage section and in which (i) a time or a time period at or during which a speech input is to be carried out and (ii) a keyword that is indicative of at least part of a predictable result of speech recognition are associated with each other, and determine not to prepare the response that corresponds to the recognized information item if the speech input time or the recognition time and the result of the speech recognition which are contained in the recognized information item match the time or the time period and the predictable result of speech recognition which are contained in the determination information item, respectively.

In order to attain the above object, a determining device in accordance with one aspect of the present invention is a determining device configured to determine whether or not to cause an electronic apparatus that includes a speech input device to respond, the determining device including: a recognized information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out; a program category identifying section configured to identify a program category, the program category being a category of a program that is being broadcast on an audio broadcasting apparatus present near the speech input device; and a response determining section configured to determine whether or not to cause the electronic apparatus to carry out a response that corresponds to the recognized information item, the response determining section being configured to determine not to prepare the response that corresponds to the recognized information item if the program category identified by the program category identifying section matches a program category that has been stored in a storage section.

### Advantageous Effects of Invention

One aspect of the present invention makes it possible to appropriately determine whether or not to respond to audio from a television set, radio receiver, or the like.

### BRIEF DESCRIPTION OF DRAWINGS

FIG. 1 is a block diagram illustrating configurations of main parts of conversational robots and a cloud server which are included in a response system in accordance with Embodiment 1 of the present invention.

FIG. 2 illustrates one example of a data structure of a determination database that is stored in a storage section of the cloud server.

FIG. 3 is a flowchart of a flow of a response necessity determining process carried out by the response system.

FIG. 4 is a block diagram illustrating configurations of main parts of conversational robots and a cloud server which are included in a response system in accordance with Embodiment 2 of the present invention.

FIG. 5 is a flowchart of a flow of a response necessity determining process carried out by the response system.

FIG. 6 illustrates one example of a data structure of per-category response information which is included in a response system in accordance with Embodiment 3 of the present invention and which is stored in a storage section of a cloud server.

FIG. 7 is a block diagram illustrating configurations of main parts of conversational robots and a cloud server which are included in a response system in accordance with Embodiment 4 of the present invention.

FIG. 8 illustrates one example of a data structure of detailed response information stored in a storage section of the cloud server.

FIG. 9 is a flowchart of a flow of a response necessity determining process carried out by the response system.

FIG. 10 is a block diagram illustrating configurations of main parts of conversational robots and a cloud server which are included in a response system in accordance with Embodiment 5.

FIG. 11 illustrates one example of a data structure of a determination database stored in a storage section of the cloud server.

FIG. 12 illustrates an outline of actions carried out by the conversational robots.

FIG. 13 is a flowchart of a flow of a response necessity determining process carried out by the response system.

FIG. 14 is a block diagram illustrating configurations of main parts of conversational robots and a cloud server which are included in a response system in accordance with Embodiment 6.

### DESCRIPTION OF EMBODIMENTS

The present disclosure relates to a response system that determines, based on a result of speech recognition of an input speech and a point in time of the input or of the speech recognition, whether or not to carry out a response to the input speech. The following description will discuss example embodiments of the present disclosure with reference to drawings.

### Embodiment 1

«Configuration of Main Parts of Devices»

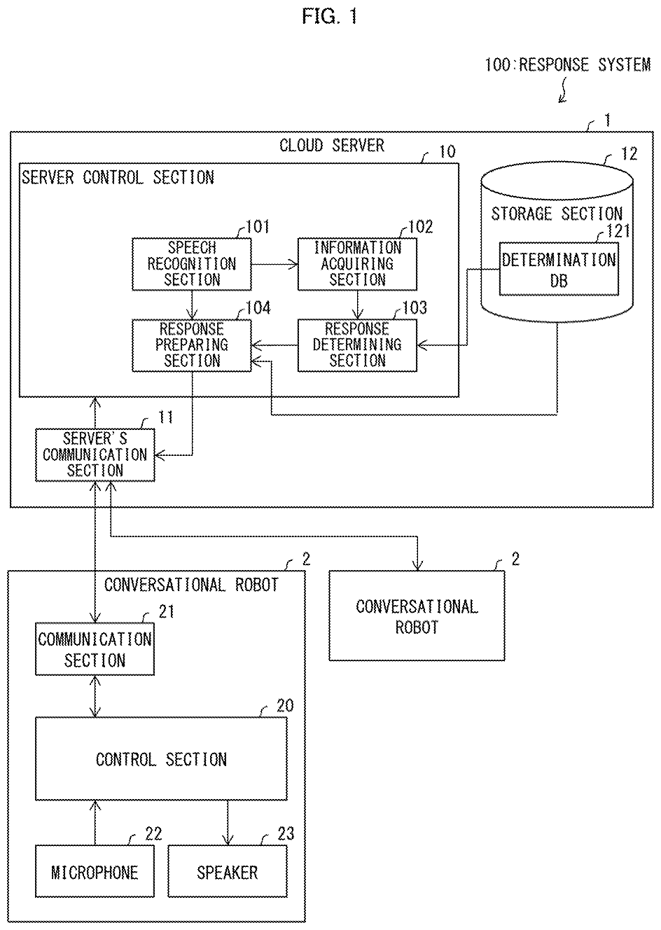

The following description will discuss Embodiment 1 of the present disclosure with reference to FIGS. 1 to 4. FIG. 1 is a block diagram illustrating configurations of main parts of conversational robots 2 and a cloud server 1 which are included in a response system 100 in accordance with Embodiment 1. The response system 100 includes at least one cloud server 1 and at least one conversational robot (electronic apparatus) 2. Although the number of conversational robots 2 in the example shown in FIG. 1 is two, the number of conversational robots 2 is not particularly limited. The two conversational robots 2 in FIG. 1 are equal in configuration to each other; therefore, one of the conversational robots 2 in FIG. 1 is illustrated in a simplified manner.

(Configuration of Main Parts of Conversational Robots 2)

Each conversational robot 2 is a robot that converses with a user by responding to a speech of the user. The conversational robot 2 includes, as illustrated in FIG. 1, a control section (determining device) 20, a communication section 21, a microphone (speech input device) 22, and a speaker (responding section) 23.

The communication section 21 serves to communicate with the cloud server 1. The microphone 22 serves to input, into the control section 20, a sound around the conversational robot 2 as an input speech.

The control section 20 serves to carry out an overall control of the conversational robot 2. The control section 20 is configured to, upon receipt of a speech inputted via the microphone 22, acquire a time at which the speech was inputted (speech input time). The speech input time may be determined by any method, and may be determined based on, for example, an internal clock of the control section 20 or the like. The control section 20 sends the acquired speech to the cloud server 1 via the communication section 21. The speech, when sent from the control section 20 to the cloud server 1, may be assigned the speech input time and identification information that identifies the conversational robot 2 in which the control section 20 is included (such identification information is referred to as robot identification information). The control section 20 also serves to cause the speaker 23 to output a response message (described later) that is received from the cloud server 1 via the communication section 21. The speaker 23 outputs the response message in a sound form in accordance with control by the control section 20.

Embodiment 1 is based on the assumption that the conversational robot 2 outputs a response in the form of a voice message; however, the conversational robot 2 may carry out a response to a user's speech by some means other than the voice message. For example, the conversational robot 2 may include a display device in addition to or instead of the speaker 23 and may cause the display device to display a message. Additionally or alternatively, the conversational robot 2 may include a movable part and a motor and may show a response using a gesture. Additionally or alternatively, the conversational robot 2 may include a lamp comprised of a light emitting diode (LED) or the like at a position viewable by the user and may show a response using blinking light.

(Configuration of Main Parts of Cloud Server 1)

The cloud server 1 determines whether or not to cause each conversational robot 2 to carry out a response. The cloud server 1 collects speeches from the conversational robots 2, carries out speech recognition of each of the speeches, and determines, based on the result of the speech recognition and the point in time of the speech recognition, whether or not to cause each conversational robot 2 to carry out a response. Embodiment 1 is based on the assumption that the response system 100 employs, as illustrated in FIG. 1, the cloud server 1 using a cloud network; however, the response system 100 may employ, instead of the cloud server 1, one or more servers that make a wired or wireless connection to the conversational robots 2. The same applies to the subsequent embodiments. In the response system 100 in accordance with Embodiment 1, the conversational robots 2 may each be an apparatus that has the functions of the cloud server 1 (described below) and that is operable alone (operable without the cloud server 1).

The cloud server 1 includes a server control section (determining device) 10, a server's communication section 11, and a storage section 12, as illustrated in FIG. 1. The server's communication section 11 serves to communicate with the conversational robots 2. The storage section 12 stores various kinds of data for use in the cloud server 1.

Specifically, the storage section 12 at least stores a determination database 121 (a collection of data for use in determination, hereinafter referred to as determination DB). The storage section 12 also stores data for use in preparation of a response message (e.g., forms or templates for response messages).

(Determination DB)

The determination DB 121 is a database that is referenced to determine whether or not to prepare a response message and that stores one or more determination information items. As used herein, the “determination information” item refers to an information item in which (i) a time or a time period at or during which a speech input is to be carried out and (i) a keyword that is indicative of a predictable result of speech recognition, are associated with each other.

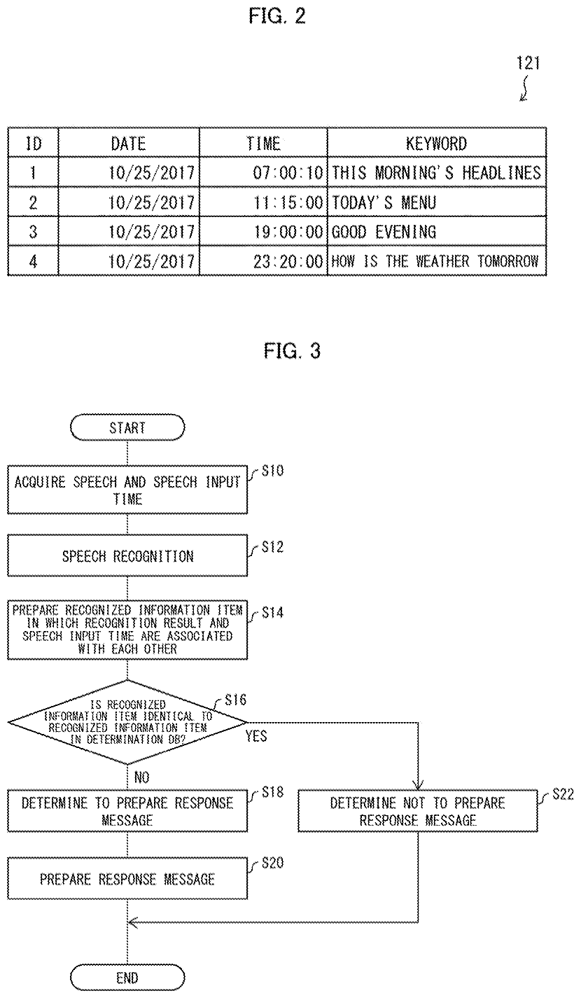

FIG. 2 illustrates one example of a data structure of the determination DB 121. In the example shown in FIG. 2, the determination DB 121 includes an “ID” column, a “DATE” column, a “TIME” column, and a “KEYWORD” column. Each record in FIG. 2 represents one determination information item. Note that the “DATE” column and “TIME” column may be integral with each other. Also note that the pieces of data in the “DATE” column and “TIME” column may indicate a time period from one time to another time, instead of indicating a point in time.

In the “ID” column, an identification code that uniquely identifies a determination information item is stored. In the determination DB 121, the data in the “ID” column is not essential. In the “DATE” column and “TIME” column, the month/date/year included in the time at which a speech input is to be carried out and the time included in the time at which the speech input is to be carried out are stored, respectively. In the “KEYWORD” column, a keyword that is indicative of at least part of a predictable result of speech recognition is stored.

Each record in the determination DB 121, that is, each determination information item, is prepared by the cloud server 1 or some other apparatus and pre-stored. The determination information item may be, for example, an information item indicative of a keyword that will possibly emanate at a certain point in time or during a certain time period from an audio broadcasting apparatus such as a television set or a radio receiver present near a corresponding robot 2.

That is, it is preferable that a keyword that is stored in the “KEYWORD” column of the determination DB 121 is at least part of a speech that is scheduled to be uttered in a television program, radio program, or the like, and preferable that the time (or time period) stored in the “DATE” column and “TIME” column is a time or a time period at or during which the speech is projected to be uttered in that program.

By employing such an arrangement in which the determination DB 121 stores, as a determination information item, (i) at least part of the speech that is scheduled to be uttered in a to-be-broadcast program or in a program that is being broadcast and (ii) when the speech is to be uttered, it is possible for the response determining section 103 (described later) to prevent a corresponding robot 2 from responding to that speech.

The server control section 10 serves to carry out an overall control of the cloud server 1. The server control section 10 includes a speech recognition section 101, an information acquiring section (recognized information acquiring section) 102, the response determining section 103, and a response preparing section 104. The server control section 10 receives the speech and its associated speech input time from the conversational robot 2 via the server's communication section 11. In cases where two or more conversational robots 2 are included in the response system 100, the server control section 10 receives, from each of the conversational robots 2, not only a speech and a speech input time but also robot identification information that identifies each of the conversational robots 2. Then, the server control section 10 carries out the following process on each of the speeches.

The speech recognition section 101 carries out speech recognition of the speeches received from the conversational robots 2. A method of the speech recognition is not limited to a particular kind. Embodiment 1 is based on the assumption that, by the speech recognition, words and phrases contained in a speech are converted into a character string. The speech recognition section 101 sends, to the response preparing section 104, the result of the speech recognition (hereinafter referred to as “recognition result” for short) that has associated therewith the robot identification information indicative of the conversational robot 2 from which the speech subjected to the speech recognition has been received.

The speech recognition section 101, after carrying out the speech recognition, prepares a recognized information item in which the recognition result and the speech input time are associated with each other. The speech recognition section 101 sends the recognized information item to the information acquiring section 102. The information acquiring section 102 sends, to the response determining section 103, the recognized information item acquired from the speech recognition section 101.

The response determining section 103 determines whether or not to prepare a response message (that is, whether or not to cause a corresponding conversational robot to carry out a response), based on the recognized information item received from the information acquiring section 102. Specifically, the response determining section 103 refers to the determination DB 121 in the storage section and determines whether the determination DB 121 contains a record indicative of (i) a time identical to the time (speech input time) contained in the recognized information item and (ii) a keyword identical to that of the result of speech recognition contained in the recognized information item. It should be noted that, if a determination information item is indicative of a time period instead of a time, the time period contained in the determination information item and a time contained in a recognized information item can be regarded as “identical”, provided that the time contained in the recognized information item falls within the time period contained in the determination information item.

If the determination DB 121 does not contain a record that is indicative of a time and keyword identical to those contained in the recognized information item, the response determining section 103 determines to prepare a response message. On the contrary, if the determination DB 121 contains a record that is indicative of a time and keyword identical to those contained in the recognized information item, the response determining section 103 determines not to prepare a response message.

It should be noted that the term “identical” or “same” used in Embodiment 1 refers to either exact matching or matching within a predetermined buffer (that is, substantially identical or partially identical). For specific example, the following arrangement may be employed: if the percentage of matching between a character string of a recognition result and a keyword contained in a determination information item is equal to or greater than a predetermined threshold, the two are determined as “indicating identical keywords”. Alternatively, the following arrangement may be employed: a speech input time and a time indicated by a determination information item are compared to each other and, if the difference between the two is within a predetermined time range, the two are determined as “identical times”. The same applies to the following embodiments.

The response preparing section 104 prepares a response message that corresponds to the recognition result, and sends the response message to the robot 2. More specifically, the response preparing section 104, after receiving from the response determining section 103 the result of determination indicating that a response message is to be prepared, refers to a response message template or the like in the storage section 12 to thereby prepare a response message that corresponds to the recognition result. The response preparing section 104 sends the prepared response message to a corresponding conversational robot 2 via the server's communication section 11. In so doing, the response preparing section 104 may send the response message to a conversational robot 2 that is indicated by the robot identification information associated with the recognition result. This makes it possible to send, back to one conversational robot 2, a response message that corresponds to the speech acquired at that conversational robot 2.

«Flow of Process»

Next, a flow of a process of determining whether or not to prepare a response message (such a process is referred to as a response necessity determining process) carried out by the response system 100 is described with reference to FIG. 3. FIG. 3 is a flowchart of a flow of the response necessity determining process carried out by the response system 100. Note that the example shown in FIG. 3 shows a flow of the response necessity determining process carried out in regard to a certain input speech (in regard to a single input).

The control section 20 of a conversational robot 2, upon receipt of an ambient sound (speech) via the microphone 22, acquires a speech input time. The control section 20 sends, to the cloud server 1, the input speech that has the speech input time (and robot identification information) associated therewith. The server control section 10 of the cloud server 1 acquires the speech and the speech input time (and the robot identification information) (S10). The speech recognition section 101 carries out speech recognition of the acquired speech (S12), and prepares a recognized information item in which the recognition result and the speech input time are associated with each other (S14). The speech recognition section 101 sends the recognized information item to the information acquiring section 102.

Upon receipt of the recognized information item (recognized information acquiring step), the information acquiring section 102 sends the recognized information item to the response determining section 103. Upon receipt of the recognized information item, the response determining section 103 determines whether or not the received recognized information item is identical to any of the determination information item(s) in the determination DB 121 (S16, response determining step). Specifically, the response determining section 103 determines whether or not the determination DB 121 contains a record indicative of (i) a time identical to the speech input time indicated by the recognized information item (or a time period within which the speech input time falls) and (ii) a keyword identical to that of the result of speech recognition indicated by the recognized information item. If it is determined that the received recognized information item is identical to any of the determination information item(s) in the determination DB 121 (YES in S16), the response determining section 103 determines not to prepare a response message (S22). On the contrary, if it is determined that the received recognized information item is not identical to any of the determination information item(s) in the determination DB 121 (NO in S16), the response determining section 103 determines to prepare a response message (S18), and the response preparing section 104 prepares a response message that corresponds to the recognition result (S20). The response preparing section 104 sends the prepared response message to the conversational robot 2, and the conversational robot 2 outputs the response message via the speaker 23.

According to the above process, the response system 100 pre-stores, in the storage section, a determination information item(s) each of which contains (i) a time or a time period at or during which a speech input is to be carried out and (ii) a predictable result of speech recognition. With this arrangement, it is possible to prevent each conversational robot 2 from making a response if the time and the result of speech recognition, which are contained in a recognized information item prepared based on the speech inputted to the conversational robot 2, match the time or time period and keyword which are contained in any of the determination information item(s), respectively.

For example, in a case where the time when a keyword that should not be responded to is uttered is known in advance like in cases of television or radio broadcasting, the keyword that should not be responded to and a time at which the keyword is projected to be uttered can be pre-stored as a determination information item in the storage section.

With this, the response system 100 is capable of preventing each robot 2 from outputting a response message at an inappropriate time. Thus, the response system 100 is capable of appropriately determining whether or not to respond to the audio from a television set, radio receiver, or the like.

The speech recognition section 101 of the cloud server 1 in accordance with Embodiment 1 may acquire a recognition time when carrying out speech recognition. The recognition time is the time at which the speech recognition is carried out. The recognition time is obtained based on, for example, a time determining section (not illustrated) of the cloud server 1, a control clock of the server control section 10, or the like. The recognized information item prepared by the speech recognition section 101 may be an information item in which the speech is associated with the recognition time, instead of the information item in which the speech is associated with the speech input time. In this case, the control section 20 of each conversational robot 2 may send a speech alone or a speech that has robot identification information associated therewith to the cloud server 1, without acquiring a speech input time. The same applies to the subsequent embodiments.

### Embodiment 2

A response system in accordance with the present disclosure may be arranged to identify a category (referred to as “program category”) of a program that is being broadcast on an audio broadcasting apparatus such as a television set or a radio receiver present near a robot 2. The response system may further be arranged such that, if the identified program category matches a program category pre-stored in a storage section, the response system determines not to prepare a response that corresponds to a recognized information item even if the recognized information item is acquired.

The following description will discuss Embodiment 2 of the present disclosure. For convenience of description, members having functions identical to those described in Embodiment 1 are assigned identical referential numerals, and their descriptions are omitted here.

«Configuration of Main Parts»

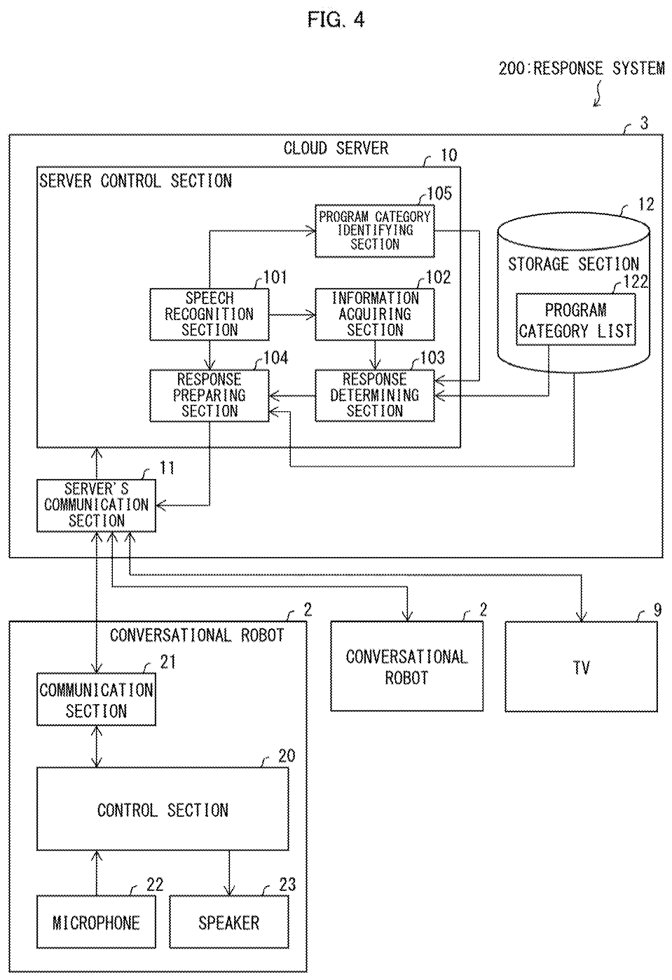

FIG. 4 is a block diagram illustrating configurations of main parts of conversational robots 2 and a cloud server 3 which are included in a response system 200 in accordance with Embodiment 2. The response system 200 is different from the response system 100 in that the response system 200 includes a television (TV) 9. A cloud server 3 of the response system 200 is different from the cloud server 1 in that the cloud server 3 includes a program category identifying section 105 and a program category list 122.

The television 9 is an audio broadcasting apparatus that is present near robots 2. As used herein, the phrase “present near” means that the television 9 is spaced from a robot 2 by a distance that is short enough to enable the microphone 22 of the robot 2 to acquire audio emanating from the television 9. The television 9 may be connected with some relevant apparatus such as a recorder for the television 9. FIG. 4 is based on the assumption that the main body of a television and its relevant apparatus(es) are collectively referred to as the television 9.

The television 9 sends “being-watched program information” to the cloud server 3 spontaneously or in response to an instruction from the server control section 10 of the cloud server. As used herein, the “being-watched program information” refers to information that contains information based on which a program category of a program that is being broadcast on the television 9 can be identified. The television 9 sends the being-watched program information to the cloud server 3 at a prescribed point in time or at a prescribed time interval(s). The prescribed point in time is, for example, a point in time at which the broadcasting of a program starts on the television 9 or a point in time at which broadcast programs are switched. The television 9 detects that the broadcasting of a program has started or that broadcast programs have been switched, acquires being-watched program information of the started program or of a program which has been switched from another program, and sends the being-watched program information to the cloud server 3.

It should be noted that the “program that is being broadcast” may either be a program that is provided by the television 9 by real time streaming of broadcast waves or a recorded program. Furthermore, the being-watched program information may contain a timestamp of a program that is being broadcast on the television 9 (this will be described later in detail).

The television 9 may send the being-watched program information to the cloud server 3 indirectly via a robot 2, instead of directly sending the being-watched program information to the cloud server 3. In this case, the communication section 21 of the robot 2 sends, to the cloud server 3, the being-watched program information received from the television 9 and a speech and a speech input time which are attributed to the robot 2.

The server control section (program information acquiring section) 10 of the cloud server 3 acquires the being-watched program information via the server's communication section 11. The speech recognition section 101 in accordance with Embodiment 2 may send a prepared recognized information item to the program category identifying section 105.

The program category identifying section 105 identifies a category (program category) of a program that is being broadcast on the television 9, on the basis of at least one of (i) the being-watched program information acquired by the server control section 10 and (ii) the recognized information item prepared by the speech recognition section 101.

For example, the following arrangement may be employed: the program category identifying section 105 reads the information that is contained in the being-watched program information and that is indicative of a program category, and thereby determines that the program category indicated by the information is a program category of the program that is being broadcast on the television 9. This makes it possible to accurately identify a program category.

Alternatively, the program category identifying section 105 may identify a program category by a method that combines (i) the above program category identification based on the being-watched program information and (ii) program category identification based on the characteristics of the speech contained in the recognized information item. This makes it possible to more accurately identify a program category. In cases where the being-watched program information alone is used to identify a program category (that is, the recognized information item is not used), the server control section 10 does not need to include the information acquiring section 102.

The program category list 122 contains data of one or more program categories with respect to which the robot 2 is prevented from making a response. The program category list 122 is prepared and pre-stored in the storage section 12 of the cloud server 3. The program category list 122 may be such that registration or modification of data of the program category list 122 can be carried out by a user.

«Flow of Process»

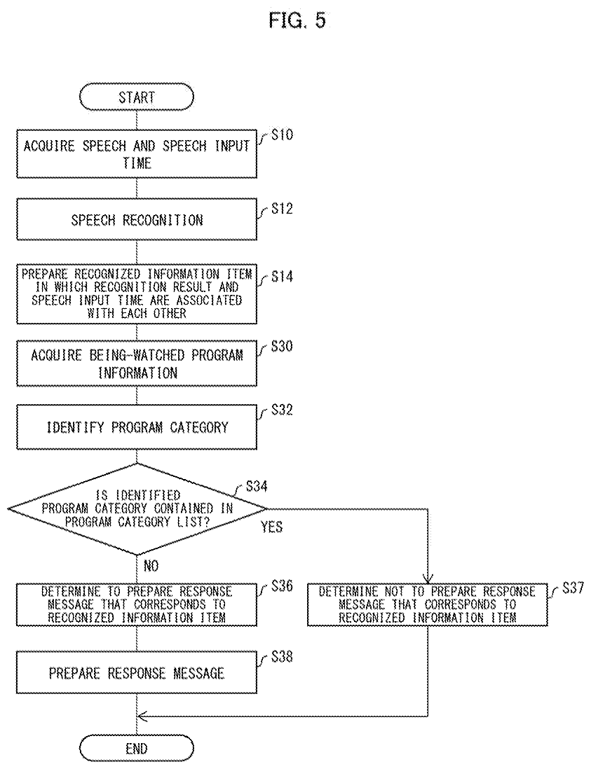

FIG. 5 is a flowchart of a flow of a response necessity determining process carried out by the response system 200. Note that steps S10 to S14 of FIG. 5 are the same as steps S10 to S14 of FIG. 3, and therefore their descriptions are omitted here.

FIG. 5 illustrates a flow of a process of identifying a program category using the being-watched program information; however, as described earlier, the program category identifying section 105 may identify a program category based on the characteristics of a speech contained in a recognized information item. In this case, the response system 200 does not need to acquire the being-watched program information.

The server control section 10 of the cloud server 3 acquires being-watched program information directly or indirectly from the television 9 (S30). Upon acquisition of the being-watched program information by the server control section 10, the program category identifying section 105 identifies a program category based on the being-watched program information (S32, program category identifying step). The program category identifying section 105 sends the identified program category to the response determining section 103.

Upon receipt of the program category, the response determining section 103 determines whether the program category is contained in the program category list 122 pre-stored in the storage section 12 (S34, response determining step). If it is determined that the program category is contained in the program category list 122 (YES in S34), the response determining section 103 determines not to prepare a response message that corresponds to a recognized information item (S37). On the contrary, if it is determined that the program category is not contained in the program category list 122 (NO in S34), the response determining section 103 determines to prepare a response message that corresponds to the recognized information item (S36).

In a case where the program category identification is carried out based on the being-watched program information as illustrated in the flowchart of FIG. 5, the point in time at which the cloud server 3 receives the being-watched program information and the point in time at which the cloud server 3 receives a speech (and a speech input time) are independent of each other. Therefore, the point in time at which the response determining section 103 determines whether or not to allow a response on the basis of the program category and the point in time at which the response preparing section 104 tries to prepare a response are also independent of each other.

Therefore, in the case where the program category identification is carried out based on the being-watched program information, the response preparing section 104 keeps the result of determination received from the response determining section 103 stored therein and, upon receipt of the recognized information item, determines whether or not to prepare a response message on the basis of the result of determination stored therein.

If the response determining section 103 determines to prepare a response message (S36), the response preparing section 104, upon acquisition of the recognized information item, prepares a response message that corresponds to the recognized information item, in accordance with the result of determination (S38).

According to the above process, one or more specific program categories are pre-stored in the program category list 122 of the storage section 12, and thereby a robot 2 is prevented from responding while a program of any of those categories is being broadcast. As such, according to the above process, it is possible to appropriately determine whether or not to respond to audio from a television set, a radio receiver, or the like.

### Embodiment 3

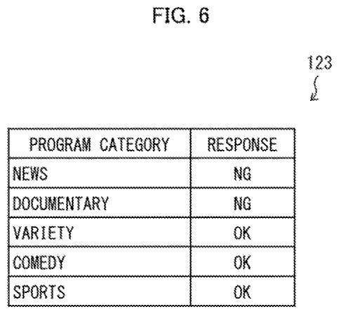

The cloud server 3 of the response system 200 may have per-category response information 123 stored therein instead of the program category list 122. In the per-category response information 123, one or more program categories are associated with response allow/disallow information items. Each of the response allow/disallow information items is indicative of whether or not a response is allowed with respect to its associated program category. In this arrangement, the response determining section 103 may be configured such that, if the program category identified by the program category identifying section 105 matches any of the program category (categories) in the per-category response information 123, the response determining section 103 determines whether or not to prepare a response based on the response allow/disallow information item associated with the matched program category. The following description will discuss Embodiment 3 of the present disclosure with reference to FIG. 6.

FIG. 6 illustrates one example of a data structure of the per-category response information 123. The per-category response information 123 is data which a program category in a “PROGRAM CATEGORY” column is associated with an information item in a “RESPONSE” column. The information item stored in the “RESPONSE” column is a response allow/disallow information item. In the example shown in FIG. 6, “NG” (disallow response) indicates that a response is not allowed, whereas “OK” (allow response) indicates that a response is allowed.

The response determining section 103 of the cloud server 3 determines, when carrying out a determination of whether or not to carry out a response in S34 of FIG. 5, whether or not the program category identified by the program category identifying section 105 is contained in the per-category response information 123. If it is determined that the identified program category is not contained in the per-category response information 123, the response determining section 103 carries out the same process as in the case of NO in S34. That is, if the category of the program that is being broadcast on the television 9 is not contained in the per-category response information 123, preparation of a response message is allowed with respect to all the speeches uttered in that program.

On the contrary, if it is determined that the identified program category is contained in the per-category response information 123, the response determining section 103 further determines whether the response allow/disallow information item corresponding to that program category indicates OK (allow response) or NG (disallow response). If the response allow/disallow information item indicates OK (allow response), the response determining section 103 determines that the preparation of a response message is allowed, and the response preparing section 104 prepares a response message that corresponds to the recognized information item. On the contrary, if the response allow/disallow information item indicates NG (disallow response), the response determining section 103 determines that the preparation of a response message is not allowed. In this case, the response preparing section 104 does not prepare a response message that corresponds to the recognized information item, and the process ends.

Note that the cloud server 3 in accordance with Embodiment 3 may carry out the same process as in the case of YES in S34 if the program category identified by the program category identifying section 105 is not contained in the per-category response information 123. Specifically, the cloud server 3 may be configured such that, if the category of the program that is being broadcast on the television 9 is not contained in the per-category response information 123, it is determined that preparation of a response message is not allowed with respect to all the speeches uttered in that program.

According to the above process, it is possible to pre-set whether or not to allow a response for each program category, in the per-category response information 123. This makes it possible for the response system 200 to more appropriately determine whether or not to respond to audio from a television set, a radio receiver, or the like.

Furthermore, the server control section (relevant information acquiring section) 10 of the cloud server 3 may acquire, via a robot 2 or an external apparatus or the like not illustrated in FIG. 4, information that is relevant to a user present near the robot 2 (such information is referred to as user-related information). In this case, the server control section (information updating section) 10 may update the per-category response information 123 stored in the storage section 12 based on the acquired user-related information. For example, a new program category and its corresponding response allow/disallow information item may be added as one record to the per-category response information 123. Additionally or alternatively, for example, the response allow/disallow information item corresponding to a certain program category contained in the per-category response information 123 may be changed.

The user-related information may be, for example, age, gender, address, family information (whether the user is in a single-person family or not), or the like of the user. Alternatively, the user-related information may be information that can be registered and modified freely by the user.

The cloud server 3 may be arranged as below: the response allow/disallow information items for all the program categories contained in the per-category response information 123 are set to NG (disallow response) in the initial state; and the response allow/disallow information items can be updated based on the foregoing user-related information or in response to an input operation by the user, for example.

This makes it possible to appropriately set whether or not to allow a response on a per-user basis. For example, in a case where the user lives on his/her own, the number of program categories for which a response is allowed can be increased. That is, it is possible to prepare per-category response information that enables a more appropriate determination of whether or not to respond to audio from a television set, a radio receiver, or the like. Note that the per-category response information 123 (especially response allow/disallow information item(s)) may be data with respect to which addition, modification, and deletion can be made freely by the user with the use of an information processor such as a personal computer (PC).

### Embodiment 4

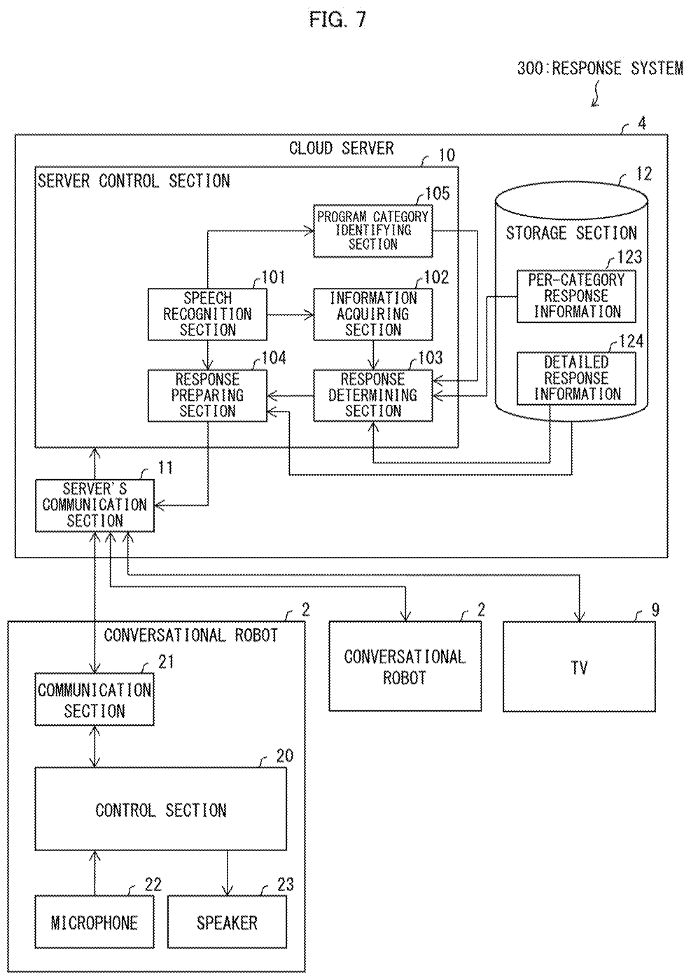

The response determining section 103 may further carry out the following determination if (i) the program category identified by the program category identifying section 105 matches any of the program category (categories) in the per-category response information 123 and (ii) the response allow/disallow information item associated with the matched program category indicates OK (allow response). Specifically, the response determining section 103 may refer to detailed response information (described later) 124 stored in the storage section 12 and, if the speech input time (or recognition time) and the result of speech recognition which are contained in the recognized information item are identical to (match) a time or time period and a result of speech recognition which are contained in any of a detailed response information item(s), determine to prepare a response that corresponds to the recognized information item. The following description will discuss Embodiment 4 of the present disclosure with reference to FIGS. 7 to 9.

FIG. 7 is a block diagram illustrating configurations of main parts of conversational robots 2 and a cloud server 4 which are included in a response system 300 in accordance with Embodiment 4. The response system 300 is different from the response systems 100 and 200 in that the storage section 12 of the response system 300 stores two kinds of information: per-category response information 123 and detailed response information 124. Note that the per-category response information 123 is the same as that described Embodiment 3, and therefore descriptions therefor are omitted here.

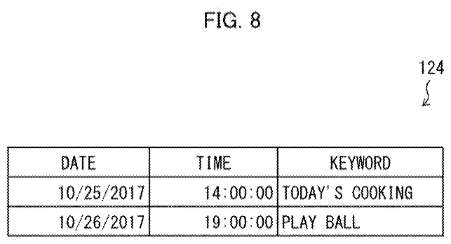

FIG. 8 illustrates one example of a data structure of the detailed response information 124. The detailed response information 124 is information which is referenced to determine whether or not to prepare a response message and which is equal in basic data structure to the determination information items in the determination DB 121 described in Embodiment 1. That is, the detailed response information 124 is information in which, at least, (i) a time or a time period at or during which a speech input is to be carried out and (ii) at least part of a keyword indicative of a predictable result of speech recognition are associated with each other. In other words, the detailed response information 124 indicates at least part of a keyword that will possibly emanate at a certain time or during a certain time period from an audio broadcasting apparatus such as a television set or a radio receiver present near the conversational robot 2.

It should be noted, however, that “at least part of a keyword” stored in the detailed response information 124 is at least part of a keyword to which the conversational robot 2 is desired to respond (react). Therefore, if the result of speech recognition matches any of the result(s) in the detailed response information 124, the cloud server 4 carries out a different process from that carried out when the result matches any of the result(s) in the determination DB 121. The process carried out by the cloud server 4 will be described later in detail.

Each record in the detailed response information 124 may be prepared and pre-stored in the storage section 12 or may be generated on an as-needed basis at a prescribed point in time. For example, if the conversational robot 2 is desired to respond in reaction to a live broadcast program, a service provider of the response system 300 may generate a record of the detailed response information 124 on an as-needed basis as the live broadcast program proceeds.

The conversational robot 2 may be configured to respond in reaction to a comment attached to a video on an online video sharing service. For example, some of the online video sharing services provide the function of attaching a comment to a video at any point in time (at any playback time) of the video. The server control section 10 of the cloud server 4 may be arranged such that, at the time when the playback of a video is started on the television 9 or at the time when a video is selected on the television 9 by the user, the server control section 10 acquires, from the television 9, the time length of the video and a comment attached to the video. In this arrangement, the server control section 10 may store, in the storage section 12, a time or a time period at or during which the comment is scheduled to appear and at least part of the comment, which are associated with each other, as one record of the detailed response information 124. As used herein, “a time or a time period at or during which the comment is scheduled to appear” means, for example, a time at which the playback time of the video, at which the comment was attached, has elapsed from the time (which is determined by the cloud server 4) when the playback of the video started.

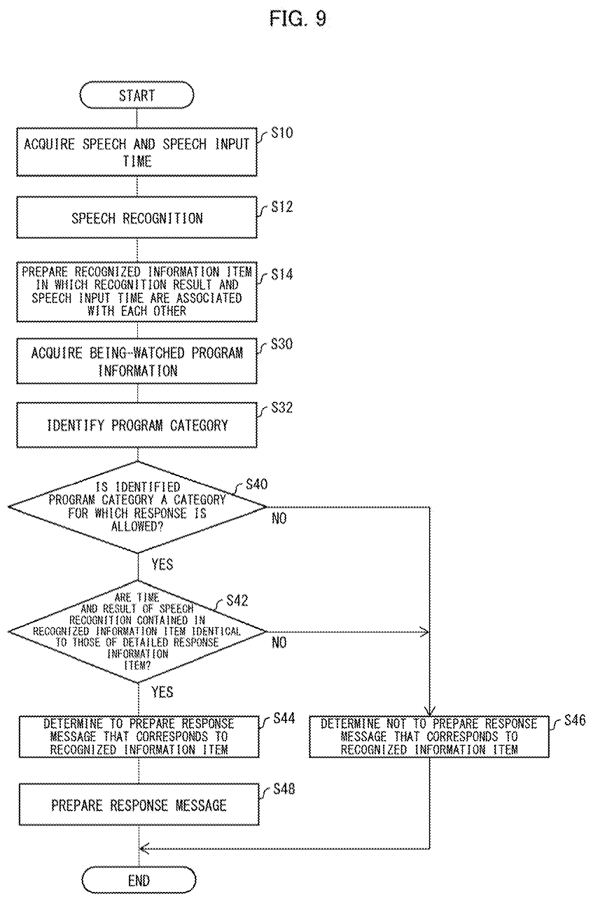

FIG. 9 is a flowchart of a flow of a response necessity determining process carried out by the response system 300. Note that steps S10 to S14 of FIG. 9 are the same as steps S10 to S14 of FIG. 3, and therefore their descriptions are omitted here. Also note that steps S30 to S32 of FIG. 9 are the same as steps S30 to S32 of FIG. 5, and therefore their descriptions are omitted here.

Upon identification of a program category, the response determining section 103 refers to the per-category response information 123, and determines whether or not the identified program category is a category for which a response is allowed (i.e., a category with which “OK” (allow response) is associated) (S40). The response determining section 103 keeps the result of the determination stored therein until it receives a recognized information item. Upon acquisition of the recognized information item, if the result of the determination is such that the identified program category is a category for which a response is allowed (YES in S40), the response determining section 103 further refers to the detailed response information 124 and determines whether or not the detailed response information 124 contains a detailed response information item that matches the speech input time (or recognition time) and the result of speech recognition which are contained in the recognized information item (S42). If it is determined that the detailed response information 124 contains such a detailed response information item (YES in S42), the response determining section 103 determines to prepare a response message (S44), and the response preparing section 104 prepares a response message that corresponds to the recognition result (S48). On the contrary, if it is determined that the detailed response information 124 does not contain such a detailed response information item (NO in S42) or the program category was a category for which a response is not allowed at the time of acquisition of the recognized information item (NO in S40), the response determining section 103 determines not to prepare a response message (S46).

According to the above process, if (i) the category of a program that is being broadcast is a program category for which a response is allowed and (ii) a predetermined keyword is uttered at a predetermined time or during a predetermined time period, the response determining section 103 determines to prepare a response that corresponds to the keyword. This makes it possible for the response system 300 to more appropriately determine whether or not to respond to audio from a television set, a radio receiver, or the like.

Note that the being-watched program information may contain a timestamp of the program that is being broadcast. The response determining section 103 may correct the speech input time (or the recognition time) contained in a recognized information item with the time indicated by the timestamp before checking the speech input time (or the recognition time) against the time(s) or the time period(s) contained in the detailed response information 124.

For example, assume that a user records a TV program for two hours from 8:00 to 10:00 on Mar. 14, 2018, that the user starts watching the program on the television 9 from 7:00 on Mar. 15, 2018, and that a robot 2 detects a speech when 15 minutes have elapsed from the start of the playback of the program (that is, at 7:15 on Mar. 15, 2018).

In this case, the speech input time sent to the cloud server 3 is “7:15 on Mar. 15, 2018”. Therefore, the speech input time contained in a recognized information item is also “7:15 on Mar. 15, 2018”. Note that the preparation of a recognized information item is carried out substantially in real time, and therefore, even if a recognition time is contained in the recognized information item instead of the speech input time, the recognition time is substantially identical to “7:15 on Mar. 15, 2018”. On the contrary, the timestamp contained in the being-watched program information indicates the time at recording, that is, “8:15 on Mar. 14, 2018”.

The response determining section 103 carries out a correction by replacing the speech input time or the recognition time contained in the recognized information item with the time indicated by the timestamp, and then determines whether or not to respond. Regarding the timestamp, timestamps indicative of the following times may be acquired: the original time when the broadcasting of the program started (in the above example, 8:00 on Mar. 14, 2018); and the playback time of the program (in the above example, 15 minutes). In this case, the speech input time or recognition time contained in the recognized information item may be corrected with a time at which the playback time has elapsed from the start time indicated by the timestamps.

This makes it possible, for example, even if the program that is being broadcast is a program that has been recorded by the user, to correct the speech input time or the recognition time with the use of a timestamp indicative of an original broadcast time and then check the corrected speech input time or recognition time against the foregoing time(s) or time period(s) in the detailed response information 124. As such, it is possible to more appropriately determine whether or not to respond to audio from a television set, a radio receiver, or the like.

Although the detailed response information 124 in accordance with Embodiment 4 is information in which a time or a time period and a keyword are associated with each other, the detailed response information 124 may be, for example, information indicative of only a time or a time period. In this case, if the program category is a category for which a response is allowed, the response determining section 103 further determines whether or not the speech input time (or recognition time) indicated by the recognized information item matches any of the time(s) or time period(s) contained in the detailed response information 124. If it is determined that the speech input time (or recognition time) indicated by the recognized information item matches any of the time(s) or time period(s) contained in the detailed response information 124, the response determining section 103 determines to prepare a response that corresponds to the recognized information item. On the contrary, if the program category is a category for which a response is allowed but the speech input time (or recognition time) indicated by the recognized information item does not match any of the time(s) or time period(s) contained in the detailed response information 124, the response determining section 103 determines not to prepare a response that corresponds to the recognized information item.

### Embodiment 5

«Configuration of Main Parts of Devices»

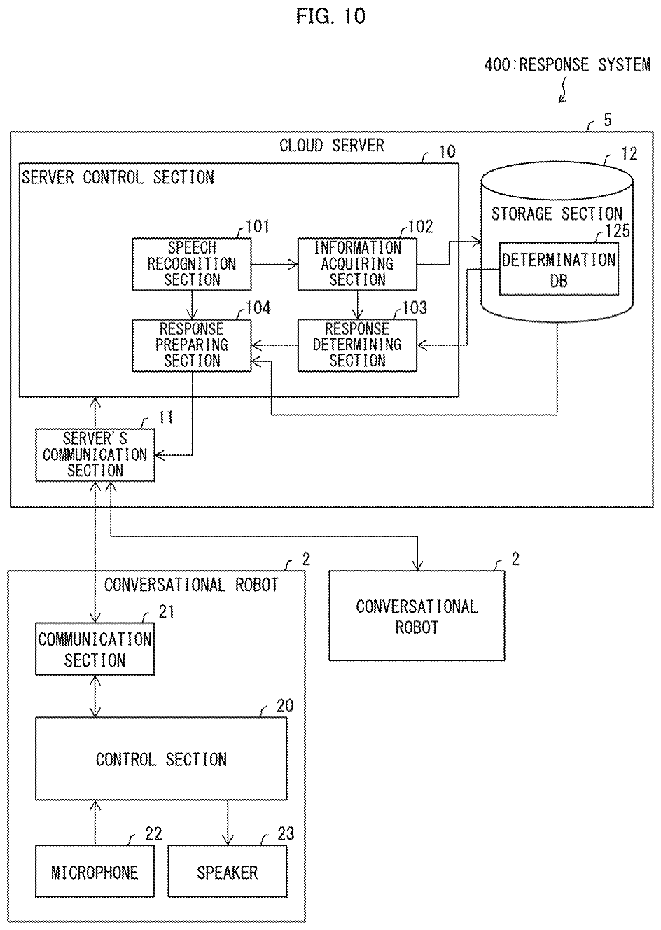

The following description will discuss Embodiment 5 of the present disclosure with reference to FIGS. 10 to 12. FIG. 10 is a block diagram illustrating configurations of main parts of conversational robots 2 and a cloud server 5 which are included in a response system 400 in accordance with Embodiment 5. The response system 400 is different from the response systems 100 to 300 in that the response system 400 necessarily includes two or more conversational robots 2.

Each conversational robot 2 is a robot that converses with a user by responding to a speech of the user. The conversational robots 2 are configured in the same manner as illustrated in FIG. 1.

The cloud server 5 determines whether or not to cause each conversational robot 2 to carry out a response. The cloud server 5 collects speeches from the conversational robots 2, carries out speech recognition of each of the speeches, and determines, based on the result of the speech recognition and the point in time of the speech recognition, whether or not to cause each conversational robot 2 to carry out a response. As illustrated in FIG. 10, the cloud server 5 includes a server control section (determining device) 10, a server's communication section 11, and a storage section 12. The server's communication section 11 serves to communicate with the conversational robots 2. The storage section 12 stores various kinds of data for use in the cloud server 5.

Specifically, the storage section 12 stores therein at least a determination database (DB) 125. The determination DB 125 in accordance with Embodiment 5 is different in data structure from the determination DB 121 illustrated in FIG. 1. The storage section 12 also stores therein data for use in preparation of a response message (e.g., forms or templates for response messages). The data structure of the determination DB 125 will be described later in detail.

The server control section 10 carries out an overall control of the cloud server 5. The server control section 10 includes a speech recognition section 101, an information acquiring section (recognized information storing section) 102, a response determining section (determination result sending section) 103, and a response preparing section 104. The server control section 10 receives speeches and their associated speech input times and robot identification information items from the conversational robots 2 via the server's communication section 11. Since the number of conversational robots 2 is two as illustrated in FIG. 1, the server control section 10 receives a speech, a speech input time, and robot identification information from each of the conversational robots 2. Then, the server control section 10 carries out the following processes on each of the speeches.

The speech recognition section 101 carries out speech recognition of the speeches received from the conversational robots 2. A method of the speech recognition is not limited to a particular kind. Embodiment 5 is based on the assumption that, by the speech recognition, words and phrases contained in a speech are converted into a character string. The speech recognition section 101 sends, to the response preparing section 104, the result of the speech recognition (hereinafter referred to as “recognition result” for short) that has associated therewith the robot identification information indicative of the conversational robot 2 from which the speech subjected to the speech recognition has been received.

The speech recognition section 101, after carrying out the speech recognition, prepares a recognized information item in which the recognition result and the speech input time are associated with each other. The speech recognition section 101 sends the recognized information item to the information acquiring section 102.

The information acquiring section 102 updates the determination DB 125 of the storage section 12 based on the recognized information item received from the speech recognition section 101. Here, the information acquiring section 102 updates the determination DB 125 in a way that depends on whether or not the determination DB 125 contains a recognized information item indicative of a recognition result and a speech input time that are identical to those of the received recognized information item. The following description discusses the details of a data structure of the determination DB 125 and the ways of updating of the determination DB 125 by the information acquiring section 102.

(Determination DB)

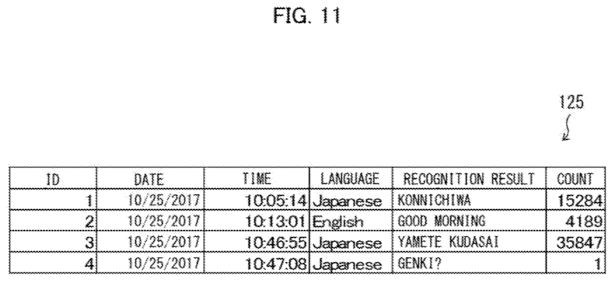

FIG. 11 illustrates one example of the data structure of the determination DB 125. The determination DB 125 is a collection of recognized information items, and is referenced to determine whether or not to prepare a response message. The determination DB 125 at least includes; data indicative of a recognition result; and data indicative of a speech input time.

In the example shown in FIG. 11, the determination DB 125 includes an “ID” column, a “DATE” column, a “TIME” column, a “LANGUAGE” column, a “RECOGNITION RESULT” column, and a “COUNT” column. Each record of FIG. 11 represents one recognized information item. The pieces of data stored in the “DATE” column, “TIME” column, “LANGUAGE” column, and “RECOGNITION RESULT” column are those which are contained in a recognized information item prepared by the speech recognition section 101. Note that the “LANGUAGE” column is not essential, and that the “DATE” column and “TIME” column may be integral with each other.

In the “ID” column, an identification code that uniquely identifies a recognized information item is stored. In the “DATE” column and “TIME” column, the month/date/year included in the speech input time and the time included in the speech input time are stored, respectively. In the “LANGUAGE” column, the type of the recognition result (the type is indicative of one, of prescribed languages, to which the recognition result belongs) is stored. The type may be determined when the speech recognition section 101 prepares the recognized information item or may be determined by the response determining section 103 based on the character string of the recognition result. In the “RECOGNITION RESULT” column, the character string of the recognition result is stored. In the “COUNT” column, the number of times the same recognized information item has been acquired is stored.

The information acquiring section 102, after acquiring the recognized information item, searches the determination DB 125 for a record which indicates a recognition result and speech input time that are identical to those of the received recognized information item. If no such records are found, the information acquiring section 102 adds a record representing the received recognized information item to the determination DB 125. In the “ID” column of the added record, a new identification code is stored. In the “COUNT” column of the added record, the number of times such a record has been acquired, that is, the number “1”, is stored.

On the contrary, if a record which indicates a recognition result and speech input time that are identical to those of the recognized information item received by the information acquiring section 102 is found, the information acquiring section 102 increments the count stored in the “COUNT” column of the found record. For example, assuming that the recognized information item received by the information acquiring section 102 is indicative of the recognition result and speech input time which are identical to those of the recognized information item with an ID of 2, the information acquiring section 102 increments the count “4189”, which is indicative of the number of times the record with an ID of 2 has been acquired, by 1 to “4190”. The information acquiring section 102, after the update of the determination DB 125 completes, sends the recognized information item acquired from the speech recognition section 101 to the response determining section 103.

Each record in the determination DB 125 may be automatically deleted after a certain period of time (e.g., 10 seconds) has passed. This makes it possible to prevent the number of records in the determination DB 125 from increasing with time, and thus possible to shorten the time from when a speech is inputted to when a response message is outputted (i.e., the time taken for conversational robot 2 to respond).

The response determining section 103 determines whether or not to prepare a response message (that is, whether or not to cause a conversational robot 2 to carry out a response), based on the recognized information item acquired from the information acquiring section 102. Specifically, the response determining section 103 determines to prepare a response message if another recognized information item (referred to as a second recognized information item) that is identical in content (at least in recognized result and speech input time) to the acquired recognized information item is not present in the determination DB 125 before the acquisition of the acquired recognized information item or within a prescribed period of time after the acquisition of the acquired recognized information item. For example, the response determining section 103 may determine that the second recognized information item is not present in the determination DB 121 if the count of the record that is identical in content to the acquired recognized information item is “1”. On the contrary, the response determining section 103 determines not to prepare a response message if such a second recognized information item is present in the determination DB 125 before the acquisition of the acquired recognized information item or within a prescribed period of time after the acquisition of the acquired recognized information item.

Note here that the response determining section 103 carries out the determination at a prescribed point in time after acquiring the recognized information item from the information acquiring section 102. For example, the response determining section 103 waits a prescribed period of time (e.g., about 1 second) after the receipt of the recognized information item, and then carries out the determination.

With this arrangement, the response determining section 103 is capable of determining not to prepare a response message that corresponds to the recognized information item not only in cases where the second recognized information item has already been acquired (and reflected to the update of the determination DB 125) before the acquisition of the recognized information item but also in cases where the second recognized information item is acquired by the information acquiring section 102 within the prescribed period of time after the acquisition of the recognized information item.

For example, in regard to sounds of television shows or the like, the same sounds are outputted (from different television sets) at different places at the same time. In such cases, a plurality of conversational robots 2 acquire the sounds substantially concurrently and send them to the cloud server 1; however, some time lag may occur between the conversational robots 2. When the response determining section 103 is configured to carry out the determination after a prescribed period of time after the update of the determination DB 125 by the information acquiring section 102, it is possible for the response determining section 103 to carry out the determination with accuracy even in cases where such a time lag occurs. Instead of delaying the determination by the response determining section 103, the sending of the recognized information item from the information acquiring section 102 to the response determining section 103 may be delayed. The response determining section 103 sends the result of the determination to the response preparing section 104.

Note that the response determining section 103 may be configured as below: if a record indicative of a recognition result and speech input time that are identical to those of the acquired recognized information item is present in the determination DB 125 and the count of that record is less than a prescribed value, the response determining section 103 determines to prepare a response, whereas, if the count of that record is equal to or greater than the prescribed value, the response determining section 103 determines not to prepare a response.

Alternatively, the response determining section 103 may be configured as below: the response determining section 103 waits (i.e., not carry out the determination) a prescribed period of time (e.g., 1 second) after the update of the determination DB 125 by the information acquiring section 102; and, if the “COUNT” of the record of the updated recognized information item (that is, the record that corresponds to the recognized information item that the response determining section 103 acquired) in the determination DB 125 does not increase while the response determining section 103 is waiting, the response determining section 103 determines to prepare a response, whereas, if the “COUNT” increases while the response determining section 103 is waiting, the response determining section 103 determines not to prepare a response.

The response preparing section 104 prepares a response message that corresponds to the recognition result, and sends the prepared response message to a robot indicated by the robot identification information associated with that recognition result. The response preparing section 104, after receiving from the response determining section 103 the result of determination indicating that a response message is to be prepared, refers to a response message template or the like in the storage section 12 to thereby prepare a response message that corresponds to the recognition result. The response preparing section 104 sends the prepared response message to a corresponding conversational robot 2 via the server's communication section 11. In so doing, the response preparing section 104 sends the response message to a conversational robot 2 that is indicated by the robot identification information associated with the recognition result. This makes it possible to send, back to one conversational robot 2, a response message that corresponds to the speech acquired at that conversational robot 2.

«Outline of Actions Carried Out by Conversational Robot 2»

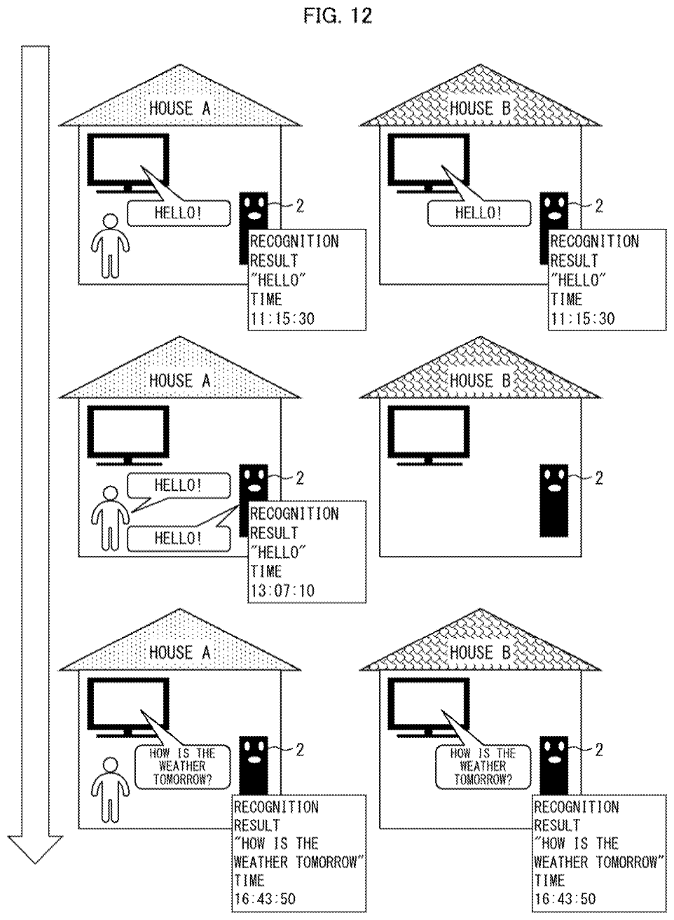

Next, an outline of actions carried out by the response system 400 in accordance with Embodiment 5 is described. FIG. 12 illustrates an outline of actions carried out by conversational robots included in the response system 400. The hollow arrow in FIG. 12 indicates a flow of time. In the example shown in FIG. 12, conversational robots 2 are located at a house A and a house B, respectively. Note that the cloud server 5 is not illustrated in the example shown in FIG. 12, assuming that the cloud server 5 is located somewhere away from the houses.

Assume that, as illustrated in FIG. 12, a television set outputs the speech “HELLO” at the time 11:15:30. In this case, the conversational robot 2 at each house acquires the speech “HELLO” and sends it to the cloud server 5. The cloud server 5 carries out speech recognition of the speech from each conversational robot 2. In the example shown in FIG. 12, the speeches of identical content are sent from the two conversational robots 2 at the houses A and B substantially concurrently to the cloud server 5, and therefore recognized information items with identical recognition results and speech input times are obtained. The information acquiring section 102 updates the determination DB 125 based on these recognized information items.

After a prescribed period of time after that, the response determining section 103 determines whether or not to carry out a response, in regard to each of the recognized information items attributed to the respective conversational robots 2. As described earlier, since a record with a recognition result and speech input time that are identical to those of the acquired recognized information items is present in the determination DB 125, the response determining section 103 determines not to prepare a response message in regard to each of the recognized information items. Therefore, the response preparing section 104 does not prepare a response message, and thus both the conversational robots 2 at the houses A and B do not output any speech.

On the contrary, assume that a user says “HELLO” to the conversational robot 2 at the house A at the time 13:07:10. In this case, a speech is sent to the cloud server 1 only from the conversational robot 2 of the house A. In this case, a record with a recognition result and speech input time that are identical to those of the prepared recognized information item is not present in the determination DB 125 before the acquisition of the prepared recognized information item or within a prescribed period of time after the acquisition of the prepared recognized information item. Therefore, the response determining section 103 determines to prepare a response message, and the response preparing section 104 sends, to the conversational robot 2, a response message “HELLO” that corresponds to the recognition result indicative of “HELLO”. Then, the conversational robot 2 outputs a speech “HELLO” via the speaker 23.

Furthermore, assume that the television sets output a speech “HOW IS THE WEATHER TOMORROW” at the time 16:43:50. In this case, as with the case of the time 11:15:30, the speeches of identical content are sent from the two conversational robots 2 at the houses A and B substantially concurrently to the cloud server 1, and therefore recognized information items with identical recognition results and speech input times are obtained. Therefore, the response determining section 103 determines not to prepare a response message in regard to each of the recognized information items, and the response preparing section 104 does not prepare a response message. Thus, both the conversational robots 2 at the houses A and B do not output any speech.

«Flow of Process»

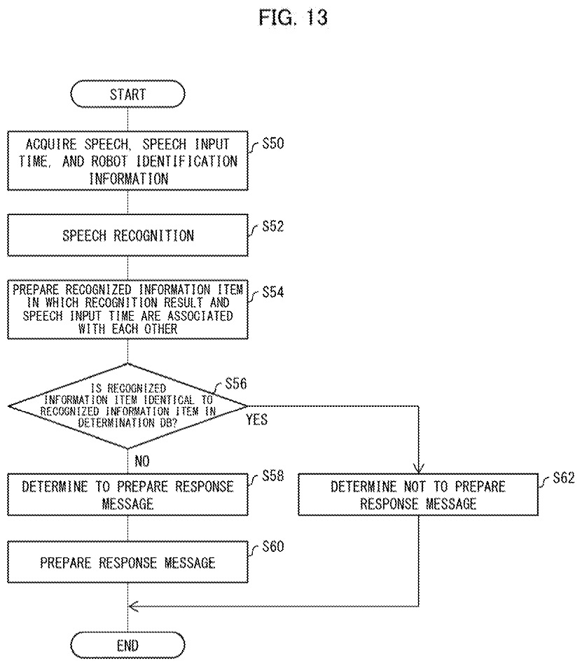

Lastly, a flow of a process of determining whether or not to prepare a response message (such a process is referred to as a response necessity determining process) carried out by the response system 400 is described with reference to FIG. 13. FIG. 13 is a flowchart of a flow of the response necessity determining process carried out by the response system 400. Note that the example shown in FIG. 13 shows a flow of the response necessity determining process carried out in regard to a certain input speech (in regard to a single input).

The control section 20 of a conversational robot 2, upon receipt of an ambient sound (speech) via the microphone 22, acquires a speech input time. The control section 20 sends, to the cloud server 1, the input speech that has the speech input time and robot identification information associated therewith. The server control section 10 of the cloud server 1 acquires the speech, the speech input time, and the robot identification information (S50). The speech recognition section 101 carries out speech recognition of the acquired speech (S52), and prepares a recognized information item in which the recognition result and the speech input time are associated with each other (S54). The speech recognition section 101 sends the recognized information item to the information acquiring section 102.

Upon receipt of the recognized information item, the information acquiring section 102 updates the determination DB 125 and sends the recognized information item to the response determining section 103. Upon receipt of the recognized information item, the response determining section 103 determines, after a prescribed period of time, whether or not the received recognized information item is identical to any of recognized information item(s) (second recognized information item(s)) in the determination DB 125 (S56). If it is determined that the received recognized information item is identical to any of the recognized information item(s) in the determination DB 121 (YES in S56), the response determining section 103 determines not to prepare a response message (S62). On the contrary, if it is determined that the received recognized information item is not identical to any of the recognized information item(s) in the determination DB 125 (NO in S56), the response determining section 103 determines to prepare a response message (S58), and the response preparing section 104 prepares a response message that corresponds to the recognition result (S60). The response preparing section 104 sends the prepared response message to the conversational robot 2 indicated by the robot identification information, and the conversational robot 2 outputs the response message via the speaker 23.

According to the above process, in cases where the recognition results of identical content are acquired at the same time, the response determining section 103 of the cloud server 1 determines, in regard to each of the recognized information items indicative of those recognition results, not to prepare a response message which corresponds to that recognized information item (that is, the response determining section 103 determines not to cause the conversational robot 2 to carry out a response).

In regard to audio from a television set, radio receiver, or the like, the same sounds are outputted (from different television sets or radio receivers) at different places at the same time. It is inferred that, in such cases, a plurality of conversational robots 2 acquire the sounds of identical content substantially concurrently and send them to the cloud server 1. According to the above arrangement, it is determined that a response be not made in such cases, and therefore possible to prevent undesired responses that would result from the audio from a television set, radio receiver, or the like.

### Embodiment 6

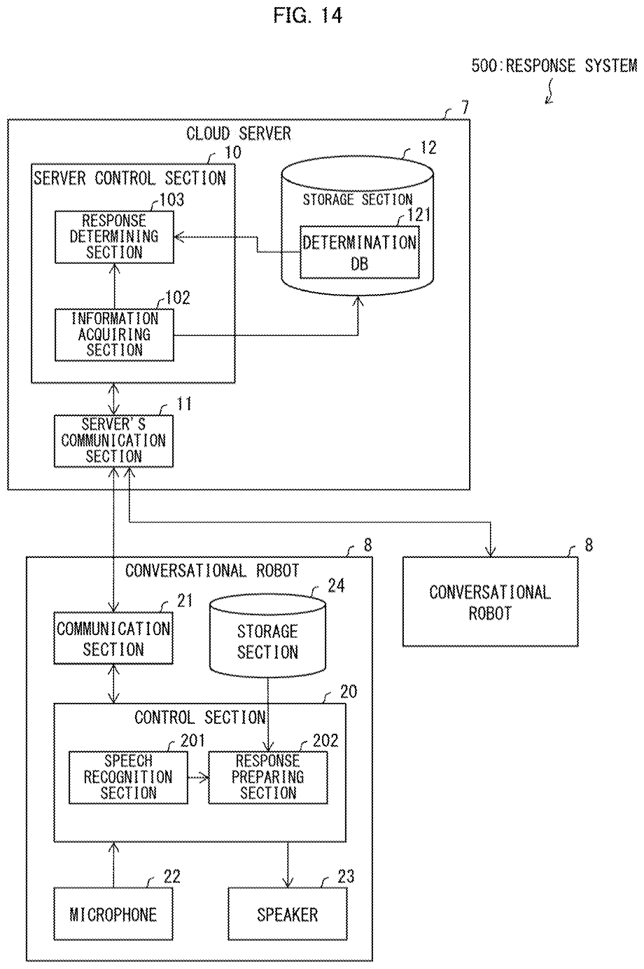

In a response system in accordance with the present disclosure, the speech recognition and the preparation of a response message may be carried out by a conversational robot. The following description will discuss Embodiment 6 of the present disclosure with reference to FIG. 14.

FIG. 14 is a block diagram illustrating configurations of main parts of conversational robots 8 and a cloud server 7 which are included in a response system 500 in accordance with Embodiment 6. The cloud server 7 is different from the cloud server 1, 3, 4, 5 in that the cloud server 7 does not include the speech recognition section 101 or the response preparing section 104. The conversational robots 8 are different from the conversational robots 2 in that the conversational robots 8 each include a storage section 24, a speech recognition section 201, and a response preparing section 202.

The storage section 24 stores data for use in preparation of a response message (e.g., forms or templates for response messages). The speech recognition section 201 has functions similar to those of the speech recognition section 101 described in the foregoing embodiments. The response preparing section 202 has functions similar to those of the response preparing section 104 described in the foregoing embodiments. According to the response system 500 in accordance with Embodiment 6, the control section 20 of each conversational robot 8 is configured to, upon receipt of a speech via a microphone 22, acquire a speech input time and carry out speech recognition through use of the speech recognition section 201. The speech recognition section 201 prepares a recognized information item in which the result of the speech recognition and the speech input time are associated with each other. The speech recognition section 201 sends, to the cloud server 7, the recognized information item having robot identification information associated therewith. The speech recognition section 201 also sends the recognized information item to the response preparing section 202.

The information acquiring section 102 of the cloud server acquires the recognized information item from the conversational robot 8, and carries out processes similar to those described in the foregoing embodiments. The response determining section 103 also carries out a determination similar to that described in the foregoing embodiments, and sends the result of the determination to the conversational robot 8 indicated by the robot identification information. The response preparing section 202 of the conversational robot 8, upon receipt of the result of determination indicating that a response message is to be prepared, refers to a response message template or the like stored in the storage section 24 to thereby prepare a response message. The control section 20 causes the speaker 23 to output the prepared response message.

In cases where a user and a conversational robot 8 are having a real-time conversation, it is important to quickly determine whether or not to carry out a response and cause the conversational robot 8 to output a response in a timely manner. According to the aforementioned processes, the cloud server 7 of the response system 500 does not carry out speech recognition and does not prepare a response message, and only carries out a determination of whether or not to carry out a response. This makes it possible to reduce the load on the cloud server 7 that is required to carry out processes in regard to a plurality of conversational robots 8. Furthermore, according to the aforementioned processes, the cloud server 7 needs only send, to a corresponding conversational robot 8, only the result of determination of whether or not to carry out a response. As such, it is possible to reduce the volume of transmitted data and to thereby reduce the load related to communications, as compared to when the cloud server 7 determines how to respond and sends, to the conversational robot 8, information indicative of how to respond. Thus, the cloud server 7 in accordance with Embodiment 6 makes it possible to carry out processes more quickly.

For example, the processing speed, which is related to the determination of whether or not to carry out a response, at the cloud server 7 also becomes quicker. This makes it possible for the conversational robots 8 to output a response message more quickly.

[Variations]

The foregoing embodiments each deal with an example in which an electronic apparatus that includes a control device is a conversational robot; however, the electronic apparatus included in the response system in accordance with each of the foregoing embodiments is not limited to the conversational robot, provided that the electronic apparatus has the conversational function. For example, the electronic apparatus(es) included in the response system may be an electrical appliance(s) such as computer equipment (e.g., a portable terminal(s) or a personal computer(s)), a speaker(s) alone, a microwave oven(s), or a refrigerator(s).

[Software Implementation Example]

Control blocks of the cloud server (1, 3, 4, 5, 7), and the conversational robots (2, 8) can be realized by a logic circuit (hardware) provided in an integrated circuit (IC chip) or the like or can be alternatively realized by software.

In the latter case, the cloud server (1, 3, 4, 5, 7), and the conversational robots (2, 8) each include a computer that executes instructions of a program that is software realizing the foregoing functions. The computer, for example, includes at least one processor (control device) and at least one computer-readable storage medium storing the program. The object of the present invention can be achieved by the processor of the computer reading and executing the program stored in the storage medium. The processor may be, for example, a CPU (Central Processing Unit). The storage medium may be “a non-transitory tangible medium” such as a ROM (Read Only Memory), a tape, a disk, a card, a semiconductor memory, and a programmable logic circuit. The computer may further include a RAM (Random Access Memory) or the like in which the program is loaded. Further, the program may be supplied to or made available to the computer via any transmission medium (such as a communication network and a broadcast wave) which enables transmission of the program. Note that one aspect of the present invention can also be implemented by the program in the form of a computer data signal embedded in a carrier wave which is embodied by electronic transmission.

[Recap]

A determining device in accordance with Aspect 1 of the present invention is a determining device configured to determine whether or not to cause an electronic apparatus that includes a speech input device to respond, the determining device including: a recognized information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out; and a response determining section configured to determine whether or not to cause the electronic apparatus to carry out a response that corresponds to the recognized information item, the response determining section being configured to refer to a determination information item which is pre-stored in a storage section and in which (i) a time or a time period at or during which a speech input is to be carried out and (ii) a keyword that is indicative of at least part of a predictable result of speech recognition are associated with each other, and determine not to prepare the response that corresponds to the recognized information item if the speech input time or the recognition time and the result of the speech recognition which are contained in the recognized information item match the time or the time period and the predictable result of speech recognition which are contained in the determination information item, respectively.

According to the above arrangement, (i) a time or a time period at or during which a speech input is to be carried out and (ii) a predictable result of speech recognition are pre-stored as a determination information item, and thereby it is possible, if the recognized information item from the speech input device matches the time or time period and the result of speech recognition, to cause the electronic apparatus not to respond.

Incidentally, in a case where the time when a keyword that should not be responded to is uttered is known in advance like in cases of television or radio broadcasting, the keyword that should not be responded to and a time at which the keyword is projected to be uttered can be pre-stored as a determination information item. With this, the determining device is capable of preventing an electronic apparatus from outputting a response message at an inappropriate time. Thus, the above arrangement is capable of appropriately determining whether or not to respond to the audio from a television set, radio receiver, or the like.

A determining device in accordance with Aspect 2 of the present invention may be arranged such that, in Aspect 1: the keyword in the determination information item is at least part of a speech that is scheduled to be uttered in a to-be-broadcast program or in a program that is being broadcast; and the time or the time period in the determination information item is a time or a time period at or during which the speech is projected to be uttered in the to-be-broadcast program or the program that is being broadcast.

According to the above arrangement, it is possible to cause the electronic apparatus not to respond to a speech that is uttered at a certain point in time in a certain program. Thus, the above arrangement makes it possible to appropriately determine whether or not to respond to the audio from a television set, a radio receiver, or the like.

A determining device in accordance with Aspect 3 of the present invention is a determining device configured to determine whether or not to cause an electronic apparatus that includes a speech input device to respond, the determining device including: a recognized information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out; a program category identifying section configured to identify a program category of a program that is being broadcast on an audio broadcasting apparatus present near the speech input device; and a response determining section configured to determine whether or not to cause the electronic apparatus to carry out a response that corresponds to the recognized information item, the response determining section being configured to determine not to prepare the response that corresponds to the recognized information item if the program category identified by the program category identifying section matches a program category pre-stored in a storage section.

According to the above arrangement, a specific program category can be stored in the storage section, and thereby the electronic apparatus can be prevented from responding to a speech inputted via the speech input device while a program of that category is being broadcast. As such, the above arrangement makes it possible to appropriately determine whether or not to respond to the audio from a television set, a radio receiver, or the like.

A determining device in accordance with Aspect 4 of the present invention may be arranged such that, in Aspect 3, the determining device further includes a program information acquiring section configured to acquire being-watched program information from the audio broadcasting apparatus or from an apparatus related to the audio broadcasting apparatus, the being-watched program information containing information based on which the program category of the program that is being broadcast can be identified, the program category identifying section being configured to identify the program category based on the being-watched program information acquired by the program information acquiring section.

According to the above arrangement, it is possible to acquire, from an audio broadcasting apparatus on which a program is broadcast or from an apparatus related to the audio broadcasting apparatus, the being-watched program information that is used to identify a program category. This makes it possible to unfailingly identify the program category.

A determining device in accordance with Aspect 5 of the present invention may be arranged such that, in Aspect 3 or 4, the program category identifying section is configured to identify the program category based on a characteristic of the speech inputted to the speech input device.

According to the above arrangement, provided that an input speech is acquired, the program category can be identified without use of any other feature that acquires some information and without having to carry out any other processes. As such, the above arrangement makes it possible to reduce the number of components of the determining device.

A determining device in accordance with Aspect 6 of the present invention may be arranged such that, in any one of Aspects 3 to 5: the storage section has a per-category response information item pre-stored therein, the per-category response information item being an information item in which a program category is associated with a response allow/disallow information item that is indicative of whether or not a response is allowed; and the response determining section is configured to, if the program category identified by the program category identifying section matches the program category in the per-category response information item, determine to prepare the response that corresponds to the recognized information item if the response allow/disallow information item associated with the program category in the per-category response information item indicates that a response is allowed, determine not to prepare the response that corresponds to the recognized information item if the response allow/disallow information item associated with the program category in the per-category response information item indicates that a response is not allowed.

According to the above arrangement, it is possible to pre-set whether or not to allow a response for each program category, in per-category response information. As such, the above arrangement makes it possible to more appropriately determine whether or not to respond to the audio from a television set, a radio receiver, or the like.

A determining device in accordance with Aspect 7 of the present invention may be arranged such that, in Aspect 6, the determining device further includes: a relevant information acquiring section configured to acquire user-related information via the speech input device or an external apparatus, the user-related information being information related to a user present near the speech input device; and an information updating section configured to update the per-category response information item in the storage section based on the user-related information acquired by the relevant information acquiring section.

According to the above arrangement, the content of per-category response information can be updated based on the user-related information. For example, a new program category and its corresponding response allow/disallow information item can be added as a per-category response information item. Additionally or alternatively, for example, the response allow/disallow information item corresponding to a certain program category contained in the per-category response information can be changed.

As such, the above arrangement makes it possible to prepare per-category response information that is used to more appropriately determine whether or not to respond to the audio from a television set, a radio receiver, or the like.

A determining device in accordance with Aspect 8 of the present invention may be arranged such that, in Aspect 6 or 7, the response determining section is configured further to, if the program category identified by the program category identifying section matches the program category in the per-category response information item and the response allow/disallow information item associated with the program category in the per-category response information item indicates that a response is allowed, refer to a detailed response information item which is stored in the storage section and in which (i) a time or a time period at or during which a speech input is to be carried out and (ii) a keyword that is indicative of at least part of a predictable result of speech recognition are associated with each other, and determine to prepare the response that corresponds to the recognized information item if the speech input time or the recognition time and the result of the speech recognition which are contained in the recognized information item match the time or the time period and the predictable result of speech recognition which are contained in the detailed response information item, respectively.

In a case where the time when a keyword that is to be responded to is uttered (or probably uttered) is known in advance like in cases of TV or radio broadcasting, the keyword that is to be responded to and a time at which the keyword is projected to be uttered can be pre-stored as a detailed response information item.

According to the above arrangement, if (i) the category of a program that is being broadcast is a program category for which a response is allowed and (ii) a predetermined keyword is uttered at a predetermined time or during a predetermined time period, the determining device determines to prepare a response that corresponds to the keyword. As such, the above arrangement makes it possible to more appropriately determine whether or not to respond to the audio from a television set, a radio receiver, or the like.

A determining device in accordance with Aspect 9 of the present invention may be arranged such that, in Aspect 8, the determining device further includes a program information acquiring section configured to acquire being-watched program information from the audio broadcasting apparatus or from an apparatus related to the audio broadcasting apparatus, the being-watched program information containing information based on which the program category of the program that is being broadcast can be identified, the being-watched program information containing a timestamp of the program that is being broadcast, the response determining section being configured to correct the speech input time or the recognition time contained in the recognized information item with the timestamp and then check the speech input time thus corrected or the recognition time thus corrected against the time or the time period contained in the detailed response information item.

According to the above arrangement, it is possible, for example, even if the program that is being broadcast is a program that has been recorded by the user, to correct the speech input time or recognition time with the use of a timestamp indicative of an original broadcast time and then check the corrected speech input time or recognition time against the foregoing time or time period in the detailed response information item. As such, the above arrangement makes it possible to more appropriately determine whether or not to respond to the audio from a television set, a radio receiver, or the like.

A determining device in accordance with Aspect 10 of the present invention may be arranged such that, in any one of Aspects 1 to 9, the response determining section is configured to determine not to cause the electronic apparatus to carry out the response that corresponds to the recognized information item if a second recognized information item is acquired before acquisition of the recognized information item or within a prescribed period of time after the acquisition of the recognized information item, the second recognized information item being identical in content to the recognized information item.

For example, in regard to sounds of television shows or the like, the same sounds are outputted (from different television sets) at different places at the same time. According to the above arrangement, in a case where recognition results that are identical in content to each other are obtained at the same time, the determining device determines not to cause electronic apparatuses to carry out the responses that correspond to the recognized information items indicative of those recognition results. As such, the determining device is capable of preventing undesired responses that would result from audio from a television set, radio receiver, or the like.

An electronic apparatus in accordance with Aspect 11 of the present invention is an electronic apparatus including a speech input device, the electronic apparatus further including a responding section configured to carry out a response in accordance with a result of determination by the determining device recited in any one of Aspects 1 to 10.

The above arrangement brings about similar effects to those provided by the determining device recited in Aspect 1 or 3.

A response system in accordance with Aspect 12 of the present invention includes: a determining device recited in any one of Aspects 1 to 10; and an electronic apparatus recited in Aspect 11.

The above arrangement brings about similar effects to those provided by the determining device recited in Aspect 1 or 3.

A method of controlling a determining device in accordance with Aspect 13 of the present invention is a method of controlling a determining device that is configured to determine whether or not to cause an electronic apparatus that includes a speech input device to respond, the method including: a recognized information acquiring step including acquiring a recognized information item in which a result of speech recognition of a speech inputted to the speech input device is associated with a speech input time or with a recognition time, the speech input time being a time at which the speech was inputted, the recognition time being a time at which the speech recognition was carried out; and a response determining step including determining whether or not to cause the electronic apparatus to carry out a response that corresponds to the recognized information item, the response determining step including referring to a determination information item which is pre-stored in a storage section and in which (i) a time or a time period at or during which a speech input is to be carried out and (ii) a keyword that is indicative of at least part of a predictable result of speech recognition are associated with each other, and determining not to prepare the response that corresponds to the recognized information item if the speech input time or the recognition time and the result of the speech recognition which are contained in the recognized information item match the time or the time period and the predictable result of speech recognition which are contained in the determination information item, respectively.

The above arrangement brings about similar effects to those provided by the determining device recited in Aspect 1.

A method of controlling a determining device in accordance with Aspect 14 of the present invention is a method of controlling a determining device that is configured to determine whether or not to cause an electronic apparatus that includes a speech input device to respond, the method including: a recognized information acquiring step including acquiring a recognized information item in which a result of speech recognition of a speech inputted to the speech input device is associated with a speech input time or with a recognition time, the speech input time being a time at which the speech was inputted, the recognition time being a time at which the speech recognition was carried out; a program category identifying step including identifying a program category of a program that is being broadcast on an audio broadcasting apparatus present near the speech input device; and a response determining step including determining whether or not to cause the electronic apparatus to carry out a response that corresponds to the recognized information item, the response determining step including determining not to prepare the response that corresponds to the recognized information item if the program category identified by the program category identifying section matches a program category pre-stored in a storage section.

The above arrangement brings about similar effects to those provided by the determining device recited in Aspect 3.

The determining device according to the foregoing embodiments of the present invention may be realized by a computer. In this case, the present invention encompasses: a control program for the determining device which program causes a computer to operate as the foregoing sections (software elements) of the determining device so that the determining device can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 3, 4, 5, 7 cloud server
2, 8 conversational robot
9 television (audio broadcasting apparatus or apparatus relate to audio broadcasting apparatus)
10 server control section (determining device, program information acquiring section, relevant information acquiring section, information updating section)
101 speech recognition section
102 information acquiring section
103 response determining section
104 response preparing section
105 program category identifying section
11 server's communication section
12, 24 storage section
121 determination DB
122 program category list
123 per-category response information
124 detailed response information
20 control section (determining device)
201 speech recognition section
202 response preparing section
21 communication section
22 microphone (speech input device)
23 speaker

1. A determining device configured to determine whether or not to cause an electronic apparatus that includes a speech input device to respond, the determining device comprising:
a recognized information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out; and
a response determining section configured to determine whether or not to cause the electronic apparatus to carry out a response that corresponds to the recognized information item,
the response determining section being configured to
refer to a determination information item which is pre-stored in a storage section and in which (i) a time or a time period at or during which a speech input is to be carried out and (ii) a keyword that is indicative of at least part of a predictable result of speech recognition are associated with each other, and
determine not to prepare the response that corresponds to the recognized information item if the speech input time or the recognition time and the result of the speech recognition which are contained in the recognized information item match the time or the time period and the predictable result of speech recognition which are contained in the determination information item, respectively.

2. The determining device according to claim 1, wherein:
the keyword in the determination information item is at least part of a speech that is scheduled to be uttered in a to-be-broadcast program or in a program that is being broadcast; and
the time or the time period in the determination information item is a time or a time period at or during which the speech is projected to be uttered in the to-be-broadcast program or the program that is being broadcast.

3. A determining device configured to determine whether or not to cause an electronic apparatus that includes a speech input device to respond, the determining device comprising:
a recognized information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out;
a program category identifying section configured to identify a program category of a program that is being broadcast on an audio broadcasting apparatus present near the speech input device; and
a response determining section configured to determine whether or not to cause the electronic apparatus to carry out a response that corresponds to the recognized information item,
the response determining section being configured to determine not to prepare the response that corresponds to the recognized information item if the program category identified by the program category identifying section matches a program category pre-stored in a storage section.

4. The determining device according to claim 3, further comprising a program information acquiring section configured to acquire being-watched program information from the audio broadcasting apparatus or from an apparatus related to the audio broadcasting apparatus, the being-watched program information containing information based on which the program category of the program that is being broadcast can be identified,
the program category identifying section being configured to identify the program category based on the being-watched program information acquired by the program information acquiring section.

5. The determining device according to claim 3, wherein the program category identifying section is configured to identify the program category based on a characteristic of the speech inputted to the speech input device.

6. The determining device according to claim 3, wherein:
the storage section has a per-category response information item pre-stored therein, the per-category response information item being an information item in which a program category is associated with a response allow/disallow information item that is indicative of whether or not a response is allowed; and
the response determining section is configured to, if the program category identified by the program category identifying section matches the program category in the per-category response information item,
determine to prepare the response that corresponds to the recognized information item if the response allow/disallow information item associated with the program category in the per-category response information item indicates that a response is allowed,
determine not to prepare the response that corresponds to the recognized information item if the response allow/disallow information item associated with the program category in the per-category response information item indicates that a response is not allowed.

7. The determining device according to claim 6, further comprising:
a relevant information acquiring section configured to acquire user-related information via the speech input device or an external apparatus, the user-related information being information related to a user present near the speech input device; and
an information updating section configured to update the per-category response information item in the storage section based on the user-related information acquired by the relevant information acquiring section.

8. The determining device according to claim 6, wherein the response determining section is configured further to, if the program category identified by the program category identifying section matches the program category in the per-category response information item and the response allow/disallow information item associated with the program category in the per-category response information item indicates that a response is allowed,
refer to a detailed response information item which is stored in the storage section and in which (i) a time or a time period at or during which a speech input is to be carried out and (ii) a keyword that is indicative of at least part of a predictable result of speech recognition are associated with each other, and
determine to prepare the response that corresponds to the recognized information item if the speech input time or the recognition time and the result of the speech recognition which are contained in the recognized information item match the time or the time period and the predictable result of speech recognition which are contained in the detailed response information item, respectively.

9. The determining device according to claim 8, further comprising a program information acquiring section configured to acquire being-watched program information from the audio broadcasting apparatus or from an apparatus related to the audio broadcasting apparatus, the being-watched program information containing information based on which the program category of the program that is being broadcast can be identified,
the being-watched program information containing a timestamp of the program that is being broadcast,
the response determining section being configured to correct the speech input time or the recognition time contained in the recognized information item with the time stamp and then check the speech input time thus corrected or the recognition time thus corrected against the time or the time period contained in the detailed response information item.

10. The determining device according to claim 1, wherein the response determining section is configured to determine not to cause the electronic apparatus to carry out the response that corresponds to the recognized information item if a second recognized information item is acquired before acquisition of the recognized information item or within a prescribed period of time after the acquisition of the recognized information item, the second recognized information item being identical in content to the recognized information item.

11. The determining device according to claim 3, wherein the response determining section is configured to determine not to cause the electronic apparatus to carry out the response that corresponds to the recognized information item if a second recognized information item is acquired before acquisition of the recognized information item or within a prescribed period of time after the acquisition of the recognized information item, the second recognized information item being identical in content to the recognized information item.

12. An electronic apparatus comprising a speech input device,
the electronic apparatus further comprising a responding section configured to carry out a response in accordance with a result of determination by the determining device recited in claim 1.

13. An electronic apparatus comprising a speech input device,
the electronic apparatus further comprising a responding section configured to carry out a response in accordance with a result of determination by the determining device recited in claim 3.

14. A response system comprising:
a determining device configured to determine whether or not to cause an electronic apparatus that includes a speech input device to respond, the determining device comprising:
a recognized information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out; and
a response determining section configured to determine whether or not to cause the electronic apparatus to carry out a response that corresponds to the recognized information item,
the response determining section being configured to
refer to a determination information item which is pre-stored in a storage section and in which (i) a time or a time period at or during which a speech input is to be carried out and (ii) a keyword that is indicative of at least part of a predictable result of speech recognition are associated with each other, and
determine not to prepare the response that corresponds to the recognized information item if the speech input time or the recognition time and the result of the speech recognition which are contained in the recognized information item match the time or the time period and the predictable result of speech recognition which are contained in the determination information item, respectively; and
the electronic apparatus further comprising a responding section configured to carry out a response in accordance with a result of determination by the determining device.

15. A response system comprising:
a determining device configured to determine whether or not to cause an electronic apparatus that includes a speech input device to respond, the determining device comprising:
a recognized information acquiring section configured to acquire a recognized information item in which a result of speech recognition of a speech inputted to the speech input device is associated with a speech input time or with a recognition time, the speech input time being a time at which the speech was inputted, the recognition time being a time at which the speech recognition was carried out;
a program category identifying section configured to identify a program category of a program that is being broadcast on an audio broadcasting apparatus present near the speech input device; and
a response determining section configured to determine whether or not to cause the electronic apparatus to carry out a response that corresponds to the recognized information item,
the response determining section being configured to determine not to prepare the response that corresponds to the recognized information item if the program category identified by the program category identifying section matches a program category pre-stored in a storage section; and
the electronic apparatus further comprising a responding section configured to carry out a response in accordance with a result of determination by the determining device.

16. A method of controlling a determining device that is configured to determine whether or not to cause an electronic apparatus that includes a speech input device to respond, the method comprising:
a recognized information acquiring step comprising acquiring a recognized information item in which a result of speech recognition of a speech inputted to the speech input device is associated with a speech input time or with a recognition time, the speech input time being a time at which the speech was inputted, the recognition time being a time at which the speech recognition was carried out; and
a response determining step comprising determining whether or not to cause the electronic apparatus to carry out a response that corresponds to the recognized information item,
the response determining step comprising
referring to a determination information item which is pre-stored in a storage section and in which (i) a time or a time period at or during which a speech input is to be carried out and (ii) a keyword that is indicative of at least part of a predictable result of speech recognition are associated with each other, and
determining not to prepare the response that corresponds to the recognized information item if the speech input time or the recognition time and the result of the speech recognition which are contained in the recognized information item match the time or the time period and the predictable result of speech recognition which are contained in the determination information item, respectively.

17. A method of controlling a determining device that is configured to determine whether or not to cause an electronic apparatus that includes a speech input device to respond, the method comprising:
a recognized information acquiring step comprising acquiring a recognized information item in which a result of speech recognition of a speech inputted to the speech input device is associated with a speech input time or with a recognition time, the speech input time being a time at which the speech was inputted, the recognition time being a time at which the speech recognition was carried out;
a program category identifying step comprising identifying a program category of a program that is being broadcast on an audio broadcasting apparatus present near the speech input device; and
a response determining step comprising determining whether or not to cause the electronic apparatus to carry out a response that corresponds to the recognized information item,
the response determining step comprising determining not to prepare the response that corresponds to the recognized information item if the program category identified by the program category identifying section matches a program category pre-stored in a storage section.

18. A non-transitory computer-readable storage medium storing therein a control program for causing a computer to function as a determining device recited in claim 1, the control program being a program for causing the computer to function as the recognized information acquiring section and the response determining section.

19. A non-transitory computer-readable storage medium storing therein a control program for causing a computer to function as a determining device recited in claim 3, the control program being a program for causing the computer to function as the recognized information acquiring section, the program category identifying section, and the response determining section.
